(19) United States
(12) Patent Application Publication
(10) Pub. No.: US 2024/0378450 A1
(43) Pub. Date: Nov. 14, 2024

(54) METHODS AND APPARATUSES FOR TRAINING A MODEL BASED REINFORCEMENT LEARNING MODEL

(71) Applicant: Telefonaktiebolaget LM Ericsson (PUBL), Stockholm (SE)

(72) Inventors: Doumitrou Daniil Nimara, Sundbyberg (SE); Vincent Huang, SOLLENTUNA (SE); Mohammadreza Malek Mohammadi, SOLNA (SE); Jieqiang Wei, Täby (SE)

(21) Appl. No.: 18/564,687

(22) PCT Filed: May 28, 2021
(86) PCT No.: PCT/EP2021/064416

§ 371 Date: Nov. 28, 2023

(51) Int. Cl. G06N 3/092

(52) U.S. Cl. CPC G06N 3/092

(57) ABSTRACT

Embodiments described herein relate to a method and apparatus for training a model based reinforcement learning, MBRL, model for use in an environment. The method comprises obtaining a sequence of observations, oₜ, representative of the environment at a time t; estimating latent states sₜ at time t using a representation model, wherein the representation model estimates the latent states sₜ based on the previous latent states sₜ₋₁, previous actions aₜ₋₁ and the observations oₜ; generating modelled observations, o_{m,t}, using an observation model, wherein the observation model generates the modelled observations based on the respective latent states sₜ, wherein the step of generating comprises determining means and standard deviations based on the latent states sₜ; and minimizing a first loss function to update network parameters of the representation model and the observation model, wherein the first loss function comprises a component comparing the modelled observations, o_{m,t} to the respective observations oₜ.

### TECHNICAL FIELD

Embodiments described herein relate to methods and apparatuses for training a model-based reinforcement learning, MBRL, model for use in an environment. Embodiments also relate to use of the trained MBRL model in an environment, for example a cavity filter being controlled by a control unit.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Cavity filters, which may be used in base stations for wireless communications, are known for being very demanding in terms of the filter characteristics as the bandwidth is very narrow (i.e. typically less than 100 MHz) and the constraints in the rejection bands are very high (i.e. typically more than 60 dB). In order to reach a very narrow bandwidth with high rejection ratios, the selected filter topology will need many poles and at least a couple of zeros (i.e. commonly more than 6 poles and two zeros). The number of poles is directly translated in the number of physical resonators of the manufactured cavity filter. As every resonator is electrically and/or magnetically connected for some frequencies to the next one, a path from the input to output is created, allowing the energy to flow from the input to the output for the designed frequencies whilst some frequencies are rejected. When a pair of non-consecutive resonators are coupled, then an alternative path for the energy is created. This alternative path is related to a zero in the rejection band.

Cavity filters are still being dominantly used due to the low cost for mass production and high-Q-factor per resonator (especially for frequencies below to 1 GHz). This type of filters provides high-Q resonators that can be used to implement sharp filters with very fast transitions between pass and stop bands and very high selectivity. Moreover, they can easily cope with very high-power input signals.

Cavity filters are applicable from as low as 50 MHz up to several giga Hertz. This versatility in frequency range as well aforementioned high selectivity make them a very popular choice in many applications like in base stations.

The main drawback of this type of narrow band filters is that since they require a very sharp frequency response, a small tolerance in the fabrication process will impact in the final performance. A common solution to avoid extremely expensive fabrication process are based in a post-production tuning. For example, each resonator (e.g. each pole) being associated with a tuning screw which can adjust some possible inaccuracies in the manufacturing process to adjust the position of the pole, while each zero (due to consecutive or non-consecutive resonators) has another screw to control the desired coupling between two resonators and adjust the position of the zero. The tuning of these large number of poles and resonators is very demanding; thus, tuning is normally done manually by a well-trained technician who can manipulate the screws and verify the desired response using a Vector Network Analyser (VNA)). This process of tuning is a time-consuming task. Indeed, for some complex filter units the total process can take for example 30 minutes.

FIG. 1 illustrates the process of manually tuning a typical cavity filter by a human expert. The expert 100 observes the S-parameter measurements 101 on the VNA 102 and turns the screws 103 manually until the S-parameter measurements reach a desired configuration.

Recently, artificial intelligence and machine learning have emerged as potential alternatives to solve this problem, thereby reducing the required tuning time per filter unit and offering the possibility to explore more complex filter topologies.

For example, Harcher et. Al “Automated filter tuning using generalized low-pass prototype networks and gradient-based parameter extraction” IEEE Transactions on Microwave Theory and Techniques, vol. 49, no. 12, pp.2532-2538, 2001. doi:10.1109/22.971646, broke the task into first finding the underlying model parameters which generate the current S-parameter curve and then performing sensitivity analysis to adjust the model parameters so that they converge to the nominal (ideal) values of a perfectly tuned filter.

Traditional Al attempts may work well, however struggle to tackle more complicated filters with more sophisticated topologies. To this end, Lindstahl, S. (2019) “Reinforcement Learning with Imitation for Cavity Filter Tuning: Solving problems by throwing DIRT at them” (Dissertation) (retrieved from http://urn.kb.se/resolve?urn=urn:nbn:se:kth:diva-254422), managed to employ Model Free Reinforcement Learning to solve the 6p2z filter environment. One problem with these approaches is that the agent employed requires a lot of training samples to achieve the desired performance.

### SUMMARY

According to some embodiments there is provided a method for training a model based reinforcement learning, MBRL, model for use in an environment. The method comprises obtaining a sequence of observations, ot, representative of the environment at a time t; estimating latent states st at time t using a representation model, wherein the representation model estimates the latent states s¬t based on the previous latent states st−1, previous actions at−1 and the observations ot; generating modelled observations, om,t, using an observation model, wherein the observation model generates the modelled observations based on the respective latent states st, wherein the step of generating comprises determining means and standard deviations for based on the latent states st; and minimizing a first loss function to update network parameters of the representation model and the observation model, wherein the first loss function comprises a component comparing the modelled observations, om,t to the respective observations ot.

According to some embodiments there is provided an apparatus for training a model based reinforcement learning, MBRL, model for use in an environment. The apparatus comprises processing circuitry configured to cause the apparatus to: obtain a sequence of observations, ot, representative of the environment at a time t; estimate latent states st at time t using a representation model, wherein the representation model estimates the latent states s¬t based on the previous latent states st−1, previous actions at−1 and the observations ot; generate modelled observations, om,t, using an observation model, wherein the observation model generates the modelled observations based on the respective latent states st, wherein the step of generating comprises determining means and standard deviations for based on the latent states st; and minimize a first loss function to update network parameters of the representation model and the observation model, wherein the first loss function comprises a component comparing the modelled observations, om,t to the respective observations ot.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates the process of manually tuning a typical cavity filter by a human expert;

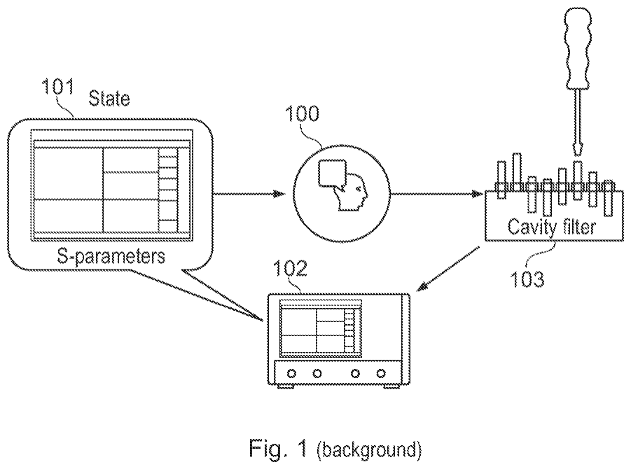

FIG. 2 illustrates an overview of a training procedure for the MBRL model according to some embodiments;

FIG. 3 illustrates the method of step 202 of FIG. 2 in more detail;

FIG. 4 graphically illustrates how step 202 of FIG. 2 may be performed;

FIG. 5 illustrates an example of a decoder 405 according to some embodiments;

FIG. 6 graphically illustrates how step 203 of FIG. 2 may be performed;

FIG. 7 illustrates how the proposed MBRL model can be trained and used in an environment comprising a cavity filter being controlled by a control unit;

FIG. 8 illustrates a typical example of VNA measurements during a training loop;

FIG. 9 is a graph illustrating an “observational bottleneck”, where in the case of the fixed non learnable standard deviation (I) 901 (as used in Dreamer), the resulting MBRL model seems to plateau after a few thousand steps, illustrating that the more simplistic world modelling does not continue learning;

FIG. 10 is a graph illustrating the observation loss 1001 for an MBRL with a learnable standard deviation according to embodiments described herein, and the observation loss 1002 for an MBRL with a fixed standard deviation;

FIG. 11 illustrates a comparison between a how quickly a Best Model Free (SAC) agent can tune a cavity filter, and how quickly an MBRL model according to embodiments described herein can tune the cavity filter;

FIG. 12 illustrates an apparatus comprising processing circuitry (or logic) in accordance with some embodiments;

FIG. 13 is a block diagram illustrating an apparatus in accordance with some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

As described above, traditionally tuning of a cavity filter is performed manually by a human expert in a lengthy and costly process. Model Free reinforcement learning (MFRL) approaches have already shown success is solving this problem. However, the MFRL approaches are not sample efficient, meaning they require a lot of training samples before obtaining a proper tuning policy. As more precise world simulations require more processing time, it may be desirable for agents to be able to learn and to solve a task whilst requiring as few interactions with the environment as possible. For reference, current 3D simulations on cavity filters require around seven minutes for a single agent interaction (carried on a 4-core cpu). Transitioning on real filters requires even more precise simulations, however, training of MFRL agents on such environments is simply unfeasible (time wise). In order to deploy such agents on real filters, a boost in sample efficiency must be achieved.

Given sufficient samples (term often called “asymptotic performance”), MFRL tends to exhibit better performance than model based reinforcement learning (MBRL), as errors induced by the world model get propagated to the decision making of the agent. In other words, the world model errors act as a bottleneck on the performance of the MBRL model. On the other hand, MBRL can leverage the world model to boost training efficiency, leading to faster training. For example, the agent can use the learned environment model to simulate sequence of actions and observations, which in turn give it a better understanding of the consequences of his actions. When designing an RL algorithm, one must find a fine balance, between training speed and asymptotic performance. Achieving both requires careful modelling and is the goal of the embodiments described herein.

Contemporary Model Based Reinforcement Learning (MBRL) techniques have rarely been used to deal with high dimensional observations such as those present when tuning cavity filters. State-of-the-art methods typically lack the precision required in this task, and as such cannot be applied as is whilst exhibiting acceptable results.

However, recent advances in Model Based Reinforcement Learning (MBRL) have been made which tackle complicated environments, while requiring fewer samples.

Embodiments described herein therefore provide methods and apparatuses for training a model based reinforcement learning, MBRL, model for use in an environment. In particular, the method of training produces a MBRL model that is suitable for use in environments having high dimensional observations, such as a tuning a cavity filter.

Embodiments described herein builds on a known MBRL agent structure referred to herein as the “Dreamer model” (see D. Hafner et al. (2020) “Mastering Atari with Discrete World Models” retrieved from https://arxiv.org/abs/2010.02193). The resulting MBRL agent according to embodiments described herein provides similar performance to previous MFRL agent whilst requiring significantly fewer samples.

Reinforcement learning is a learning method concerned with how an agent should take actions in an environment in order to maximize a numerical reward.

In some examples, the environment comprises a cavity filter being controlled by a control unit. The MBRL model may therefore comprise an algorithm which tunes the cavity filter, for example by turning the screws on the cavity filter.

The Dreamer model stands out among many other MBRL algorithms as it has achieved performance on a wide array of tasks of varying complexity while requiring significantly fewer samples (e.g. orders of magnitude less than otherwise required). It takes its name from the fact that the actor model in the architecture (which chooses the actions performed by the agent), bases its decisions purely on a lower dimensional latent space. In other words, the actor model leverages the world model to imagine trajectories, without requiring the generation of actual observations. This is particularly useful in some cases, especially where the observations are high dimensional.

The Dreamer model consists of an Actor-Critic network pair and a World Model. The World Model is fit onto a sequence of observations, so that it can reconstruct the original observation from the latent space and predict the corresponding reward. The actor model and critic model receive as an input the states, e.g. the latent representations of the observations. The critic model aims to predict the value of a state (how close we are to a tuned configuration), while the actor model aims to find the action which would lead to a configuration exhibiting a higher value (more tuned). The actor model obtains more precise value estimates by leveraging the world model to examine the consequences of the actions multiple steps ahead.

The architecture of an MBRL model according to embodiments described herein comprises one or more of: an actor model a critic model, a reward model (q(rₜ|sₜ)), a transition model (q(sₜ|sₜ₋₁, aₜ₋₁)), a representation model (p(sₜ|sₜ₋₁, aₜ₋₁, oₜ)) and an observation model (q(o_{m,t}|sₜ)). Examples of how these different models may be implemented will now be described in more detail below.

The actor model aims to predict the next action, given the current latent state sₜ. The actor model may for example comprise a neural network. The actor model neural network may comprise a sequence of fully connected layers (e.g. 3 layers with layer widths of, for example, 400, 400 and 300) which then output the mean and the standard deviation of a truncated normal distribution (e.g. to limit the mean to lie within [−1,1]).

The critic model models the value of a given state V(sₜ). The critic model may comprise a neural network. The critic model neural network may comprise a sequence of, for fully connected layers (e.g. three layers with layer widths of 400, 400 and 300) which then output the mean of the value distribution (e.g. a one-dimensional output). This distribution may be a Normal Distribution.

The reward model determines the reward given the current latent state sₜ. The reward model may also comprise a neural network. The reward model neural network may also comprise a sequence of fully connected layers (e.g. three fully connected layers with layer widths of, for example, 400, 200 and 50). The reward model may model the mean of a generative Normal Distribution.

The transition model q(sₜ|sₜ₋₁, aₜ₋₁) aims to predict the next set of latent states (sₜ), given the previous latent state (sₜ₋₁) and action (aₜ₋₁) without utilising the current observation oₜ. The transition model may be modelled as a Gated Recurrent Unit (GRU) comprised of one hidden layer which stores a deterministic state hₜ (the hidden neural network layer may have a width of 400). Alongside hₜ a shallow neural network comprised of Fully Connected Hidden layers (for example with a single layer with a layer width of, for example, 200) may be used to generate stochastic states. The states sₜ used above may comprise both deterministic and stochastic states.

The representation model (p(sₜ|sₜ₋₁, aₜ₋₁, oₜ)) is in essence the same as the transition model, with the only difference being that it also incorporates the current observation oₜ (in other words, the representation model may be considered posterior over latent states, whereas the transition model is prior over latent states). To do so, the observation oₜ is processed by an encoder and an embedding is obtained. The encoder may comprise a neural network. The encoder neural network may comprise a sequence of fully connected layers (e.g. two layers with layer widths of, for example, 600 and 400).

The observation model q(o_{m,t}|sₜ), which is implemented by a decoder, aims to reconstruct, by generating modelled observation o_{m,t}, the observation oₜ that produced the embedding which then helped to generate the latent state sₜ. The latent space must be such that the decoder is able to reconstruct the initial observation as accurately as possible. It may be important that this part of the model is as robust as possible, as it dictates the quality of the latent space, and therefore the usability of the latent space for planning ahead. In the “Dreamer” algorithm, the observation model generated modelled observations by determining means based on the latent states sₜ. The modelled observations were then generated by sampling distributions generated from the respective means.

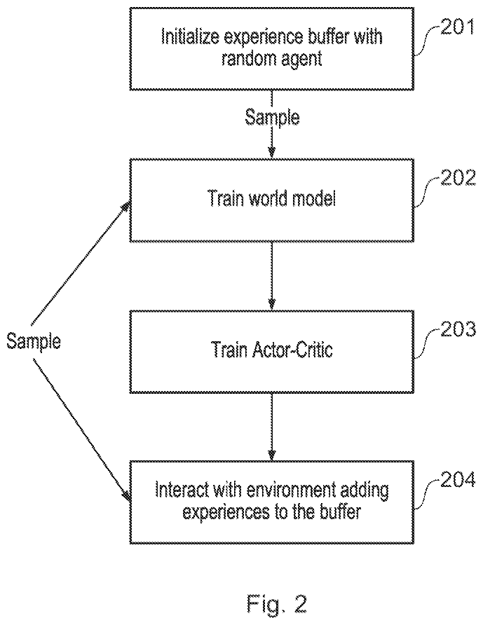

FIG. 2 illustrates an overview of a training procedure for the MBRL model according to some embodiments.

In step 201, the method comprises initialising an experience buffer. The experience buffer may comprise random seed episodes, wherein each seed episode comprises a sequence of experiences. Alternatively, the experience buffer may comprise a series of experiences not contained within seed episodes. Each experience comprises a tuple in the form (oₜ, aₜ, rₜ, oₜ₊₁).

When drawing information from the experience buffer, the MBRL model may, for example, select a random seed episode, and may then select a random sequence of experiences from the within the selected seed episode.

The neural network parameters of the various neural networks in the model may also be initialised randomly.

In step 202, the method comprises training the world model.

In step 203, the method comprises training the actor-critic model.

In step 204, the updated model interacts with the environment to add experiences to the experience buffer. The method then returns to step 202. The method may then continue until the network parameters of the world model and the actor-critic model converge, or until the performs at a desired level.

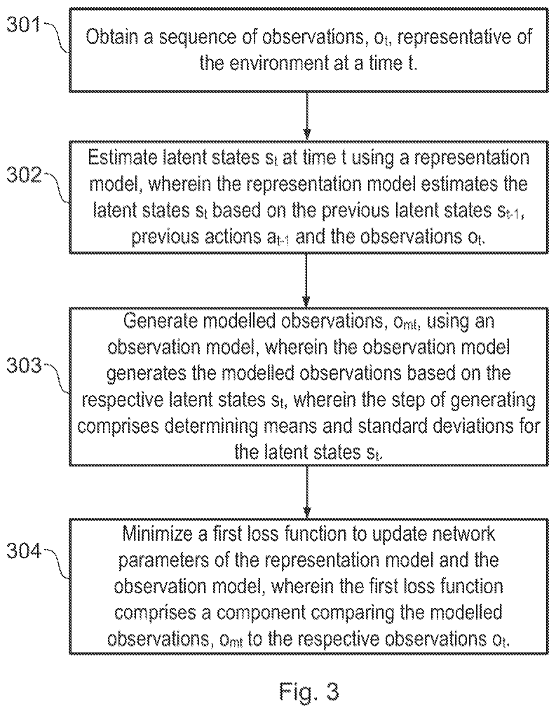

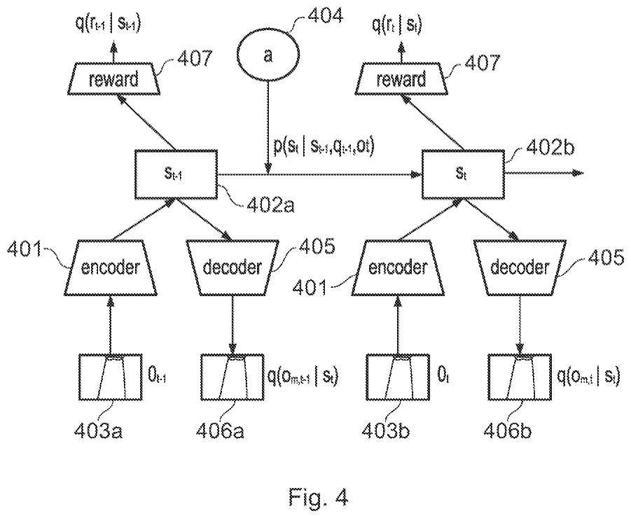

FIG. 3 illustrates the method of step 202 of FIG. 2 in more detail. FIG. 4 graphically illustrates how step 202 of FIG. 2 may be performed. In FIG. 4 all blocks that are illustrated with non-circular shapes are trainable during step 202 of FIG. 2. In other words, the neural network parameters for the models represented by the non-circular blocks may be updated during step 202 of FIG. 2.

In step 301, the method comprises obtaining a sequence of observations, oₜ, representative of the environment at a time t. For example, as illustrated in FIG. 4, the encoder 401 is configured to receive the observations oₜ₋₁ 403a (at time t−1) and oₜ 403b (at time t). The illustrated observations are S-parameters of a cavity filter. This is given as an example of a type of observation, and is not limiting.

In step 302, the method comprises estimating latent states sₜ at time t using a representation model, wherein the representation model estimates the latent states sₜ based on the previous latent states sₜ₋₁, previous actions aₜ₋₁ and the observations oₜ. The representation model is therefore based on previous sequences that have occurred. For example, the representation model estimates the latent state sₜ 402b at time t based on the previous latent state sₜ₋₁ 402a, the previous action aₜ₋₁ 404 and the observation oₜ 403b.

In step 303, the method comprises generating modelled observations, o_{m,t}, using an observation model (q(o_{m,t}|sₜ)), wherein the observation model generates the modelled observations based on the respective latent states sₜ. For example, the decoder 405 generates the modelled observations o_{m,t} 406b and o_{m,t-1} 406a based on the states stand sₜ₋₁ respectively.

The step of generating comprises determining means and standard deviations based on the latent states sₜ. For example, the step of generating may comprise determining a respective mean and standard deviation based on each of the latent states sₜ. This is in contrast to the original “Dreamer” model, which (as described above), produces only means based on the latent states in the observation model.

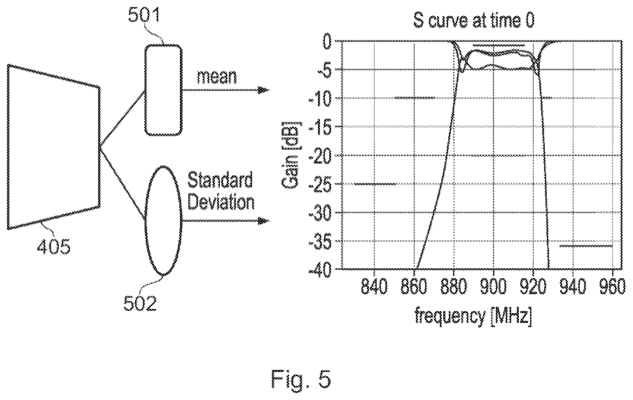

FIG. 5 illustrates an example of a decoder 405 according to some embodiments. The decoder 405 determines a mean 501 and a standard deviation 502 based on the latent state sₜ it receives as an input. As previously described the decoder comprises a neural network configured to attempt to map the latent state sₜ to the corresponding observation oₜ.

The output modelled observation o_{m,t} may then be determined by sampling a distribution generated from the determined mean and standard deviation.

In step 304 the method comprises, minimizing a first loss function to update network parameters of the representation model and the observation model, wherein the first loss function comprises a component comparing the modelled observations, o_{m,t} to the respective observations oₜ. In other words, the neural network parameters of the representation model and the observation model may be updated based on how similar the modelled observations o_{m,t} are to the observations oₜ.

In some examples the method further comprises determining a reward rₜ based on a reward model (q(rₜ|sₜ)) 407, wherein the reward model 407 determines the reward rₜ based on the latent state sₜ. The step of minimizing the first loss function may then be further used to update network parameters of the reward model. For example, the neural network parameters of the reward model may be updated based on minimizing the loss function. The first loss function may therefore further comprise a component relating to the how well the reward n represents a real reward for the observation oₜ. In other words, the loss function may comprise a component measuring how well the determined reward rₜ matches how well the observation oₜ should be rewarded.

The overall world model may therefore be trained to simultaneously maximize the likelihood of generating the correct environment rewards r and to maintain an accurate reconstruction of the original observation via the decoder.

In some examples, the method further comprises estimating a transitional latent state s_{trans,t}, using a transition model (q(s_{trans,t}|s_{trans,t-1}, aₜ₋₁)). The transition model may estimate the transitional latent state s_{trans,t} based on the previous transitional latent state s_{trans,t-1} and a previous action aₜ₋₁. In other words, the transition model is similar to the representation model, except the transition model does not take into account the observations oₜ. This allows the final trained model to predict (or “dream”) further into the future.

The step of minimizing the first loss function may therefore be further used to update network parameters of the transition model. For example, neural network parameters of the transition model may be updated. The first loss function may therefore further comprise a component relating to how similar the transitional latent state s_{trans,t} is to the latent state sₜ. The aim of updating the transition model is to ensure that the transitional latent states s_{trans,t} produced by the transition model are as similar as possible to the latent states sₜ produced by the representation model. The trained transition model may be used in the next stage, e.g. step 203 of FIG. 2.

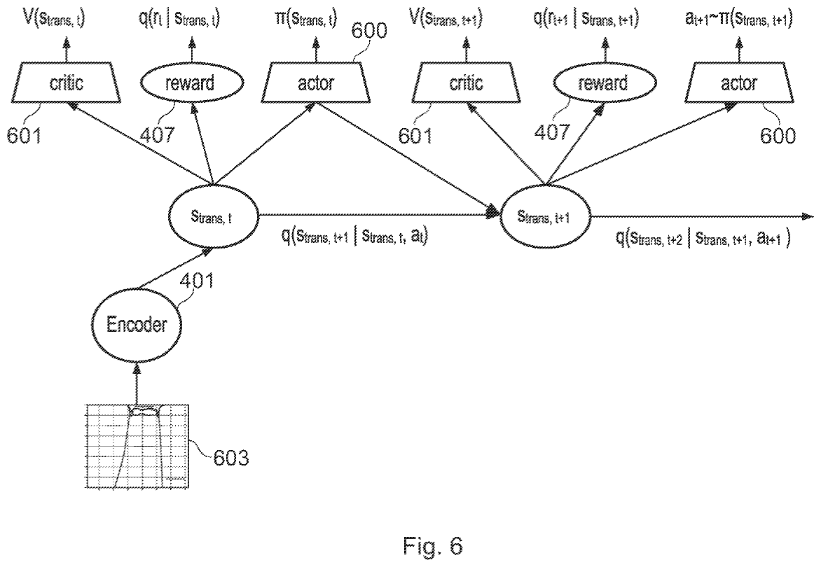

FIG. 6 graphically illustrates how step 203 of FIG. 2 may be performed. In FIG. 6, all blocks that are illustrated with non-circular shapes are trainable during step 203 of FIG. 2. In other words, the neural network parameters for the models represented by the non-circular blocks may be updated during step 203 of FIG. 2. In other words, during step 203 of FIG. 2, the actor model 600 and the critic model 601 may be updated.

Step 203 of FIG. 2 may be initiated by a single observation 603. The observation can be fed into the encoder 401 (trained in step 202), and embedded. The embedded observation may then be used to generate the starting transitional state s_{trans,t}. The trained transition model then determines the following transitional states s_{trans,t+1}, and so on, based on the previous transitional state s_{trans,t} and the previous action aₜ.

Step 203 of FIG. 2 may comprise minimizing a second loss function to update network parameters of the critic model 601 and the actor model 602. The critic model determines state values based on the transitional latent states s_{trans,t}. The actor model determines actions at based on the transitional latent states s_{trans,t}.

The second loss function comprises a component relating to ensuring the state values are accurate (e.g. observations that lie closer to tuned configurations are attributed a higher value), and a component relating to ensuring the actor model leads to transitional latent states, s_{trans,t} associated with high state values, whilst in some examples also being as explorative as possible (e.g. having high entropy).

A trained MBRL according to embodiments described herein may then interact with an environment, during which actions and observations fed into the trained encoder, and the trained representation model and actor model are used to determine appropriate actions. The resulting data samples may be fed back into the experience buffer to be used in continual training of the MBRL model.

In some examples, models may be stored periodically. The process may comprise evaluating stored MBRL models on multiple environments and selecting the best performing MBRL model for use.

The MBRL model trained according to embodiments described herein may be utilized in environments which require more precise generative models. Potentially, the MBRL model as described by embodiments herein may allow for the learning of any distribution described by some relevant statistics. The MBRL model as described by embodiments herein may significantly decrease the required number of training samples, for example, in a Cavity Filter Environment. This improvement to decrease the required number of training samples is achieved by enhancing the observation model to model a normal distribution with a learnable mean and standard deviation. The decrease in the number of required training samples may be, for example, a factor of 4.

As previously described, in some examples, the environment in which the MBRL model operates comprises a cavity filter being controlled by a control unit. The MBRL model may be trained and used in this environment. In this example, the observations, oₜ, may each comprise S-parameters of the cavity filter, and the actions aₜ relate to tuning characteristics of the cavity filter. For example, the actions may comprise turning screws on the cavity filter to change the position of the poles and the zeros.

Using the a trained MBRL model in the environment comprising a cavity filter controlled by a control unit may comprise tuning the characteristics of the cavity filter to produce desired S-parameters.

In some examples, the environment may comprise a wireless device performing transmissions in a cell. The MBRL model may be trained and used within this environment. The observations, oₜ, may each comprise a performance parameter experienced by a wireless device. For example, the performance parameter may comprise one or more of: a signal to interference and noise ratio; traffic in the cell and a transmission budget. The actions at may relate to controlling one or more of: a transmission power of the wireless device; a modulation and coding scheme used by the wireless device; and a radio transmission beam pattern. Using the trained model in the environment may comprise adjusting one of: the transmission power of the wireless device; the modulation and coding scheme used by the wireless device; and a radio transmission beam pattern, to obtain a desired value of the performance parameter.

For example, in 4G and 5G cellular communication, link adaptation technique is used to maximize the user throughput and frequency spectrum utilization. The main technique to do so, is the so-called adaptive modulation and coding (ACM) scheme in which the type and order of modulation as well as channel coding rate is selected according to channel quality indicator (CQI). Selecting the optimal ACM according to user's measured SINR (signal to noise and interference ratio) is very hard due to rapid changes in the channel between base station (gNB in 5G terminology) and user, measurements delay, and traffic changes in the cell. An MBRL model according to embodiments described herein may be utilized to find optimal policies for selecting modulation and coding schemes based on observations such as: estimated SINR, traffic in the cell, and transmission budget, to maximize a reward function which represents average throughput to the users active in the cell.

In another example an MBRL model according to embodiments described herein may be utilized for cell shaping, which is basically a way to dynamically optimize utilization of radio resources in cellular networks by adjusting radio transmission beam patterns according to some network's performance indicators. In this example, the actions may adjust the radio transmission beam pattern in order to change the observations of a network performance indicator.

In another example, an MBRL model according to embodiments described herein may be utilized in dynamic spectrum sharing (DSS), which is essentially a solution for a smooth transition from 4G to 5G so that existing 4G bands can be utilized for 5G communication without any static restructuring of the spectrum. In fact, using DSS, 4G and 5G can operate in the same frequency spectrum, and a scheduler can distribute the available spectrum resources dynamically between the two radio access standards. Considering its huge potential, an MBRL model according to embodiments described herein may be utilized to adapt an optimal policy for this spectrum sharing task as well. For example, the observations may comprise the amount of data in buffer to be transmitted to each UE (a vector), and standards that each UE can support (another vector). The actions may comprise distributing the frequency spectrum between 4G and 5G standards given a current state/time. For instance, a portion to may be distributed to 4G and a portion may be distributed to 5G.

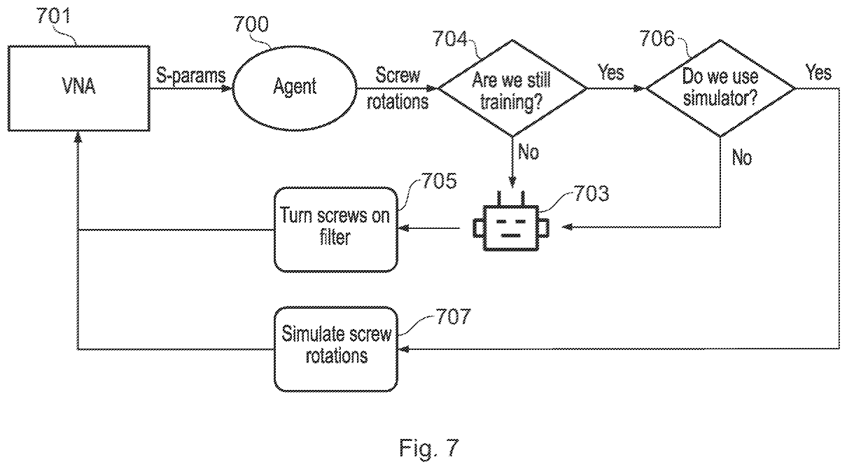

As an example, FIG. 7 illustrates how the proposed MBRL model can be trained and used in an environment comprising a cavity filter being controlled by a control unit. Overall, the MBRL model according to embodiments described herein allows for the efficient adaptation of robust state-of-the-art techniques for the process of Cavity Filter Tuning. Not only is the approach more efficient and precise than what is present in the literature, but it is also more flexible and can act as a blueprint for modelling different, potentially more complex generative distributions.

After obtaining an Agent 700 that can suggest screw rotations in simulation, the goal is to create an end-to-end pipeline which would allow for the tunning of real, physical filters. To this end, a robot may be developed which has direct access to S-parameter readings from the Vector Network Analyser (VNA) 701. Furthermore, actions can easily be translated in exact screw rotations. For example, [−1,1] may map to [−1080, 1080] degrees rotations (3 full circles). Lastly, the unit may be equipped with the means of altering the screws by the specified angle amount mentioned before.

The agent 700 may be trained by interacting either with a simulator or directly with a real filter (as shown in FIG. 7), in which case a robot 703 may be used to alter the physical screws. The goal of the agent is to devise a sequence of actions that lead to a tuned configuration as fast as possible.

The training may be described as follows:

The agent 700, given an S-parameter observation o, generates an action a, evolving the system, yielding the corresponding reward r and next observation o′. The tuple (o,a,r,o′) may be stored internally, as it can be later used for training.

The agent then checks in step 704 if it should train its world model and actor-critic networks (e.g. perform gradient updates every 10 steps). If not, it proceeds to implement the action in the environment using the robot 703 by turning the screws on the filter in step 705.

If the training is to be performed, the agent 700 may determine in step 706 whether a simulator is being used. If a simulator is being used, the simulator simulates turning the screws in step 707 during the training. If a simulator is not being used, the robot 703 may be used to turn the physical screws on the cavity filter during the training phase.

During training, the agent 700 may train the world model, for example, by updating its reward, observation, transition and representation models (as described above). This may be performed on the basis of samples (e.g. (o, a, r, o′) tuples in an experience buffer). The Actor model and the critic model may then also be updated as described above.

The goal of the agent is quantified via the reward r, which depicts the distance that the current configuration has to a tuned one. For example, the point-wise Euclidean distance between the current S-parameter values and the desired ones may be used, across the examined frequency range. If a tuned configuration is reached, the agent may, for example, receive a fixed r_{tuned} reward (e.g. +100).

If a simulator is not being used, the agent 700 may interact with the filter by changing a set of tunable parameters via the screws that are located on top of it. Thus, observations are mapped to rewards which in turn get mapped (by the agent) to screw rotations which finally lead to physical modifications via the robot 703.

After training, at inference, the agent may be employed to interact directly with the environment based on received S-parameter observations provided from the VNA 701. In particular, the agent 700 may translate the S-parameter observations into the corresponding screw rotations and may send this information to the robot 703. The robot 703 then executes the screw rotations in step 705 as dictated by the agent 700. This process continues until a tuned configuration is reached.

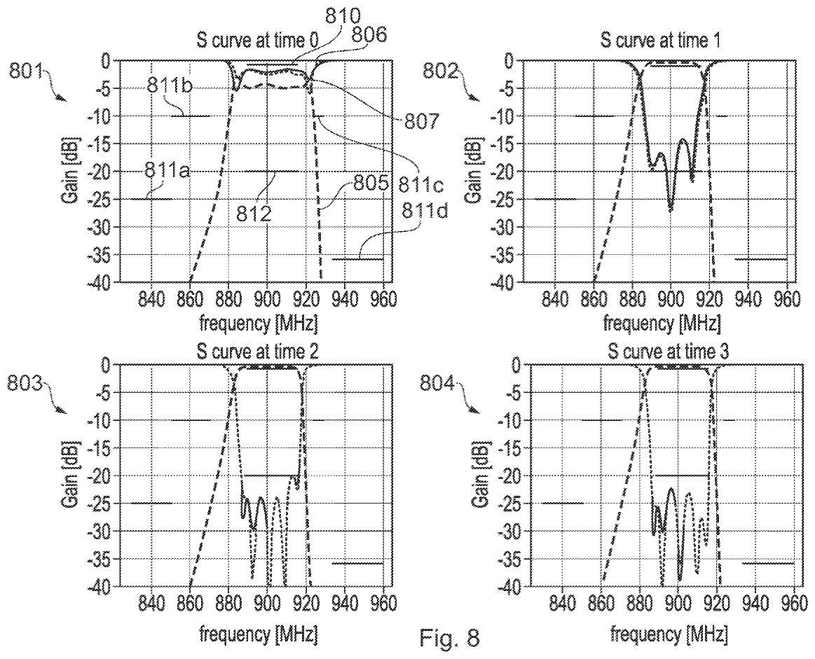

FIG. 8 illustrates a typical example of VNA measurements during a training loop.

Graph 801 illustrates a modelled observation of a S-parameter curve at a time t=0. Graph 802 illustrates a modelled observation of a S-parameter curve at a time t=1 Graph 803 illustrates a modelled observation of a S-parameter curve at a time t=2. Graph 804 illustrates a modelled observation of a S-parameter curve at a time t=3.

Requirements for what the S-parameter curve should look like in this example are indicated by the horizonal bars. For instance, the curve 805 must lie above the bar 810 in the pass band and below the bars 811a to 811d in the stop band. The curve 806 and curve 807 must lie below the bar 812 in the passband.

The MBRL model satisfies these requirements after two steps (e.g. by t=2 in Graph 803).

One of the core components of the Dreamer model is its observation model q(oₜ|sₜ), which in essence is a decoder who, given a latent representation of the environment sₜ (encapsulating information regarding previous observations, rewards and actions) aims to reconstruct the current observation oₜ (e.g. the S-parameters of filter). In the Dreamer model, the observation model models the observations via a corresponding high dimensional Gaussian N(μ(sₜ), I), where I is the identity matrix. Thus, the Dreamer model is only focused on learning the mean μ of the distribution, given the latent state sₜ. This approach is not sufficient in the environment of a cavity filter being controller by a control unit.

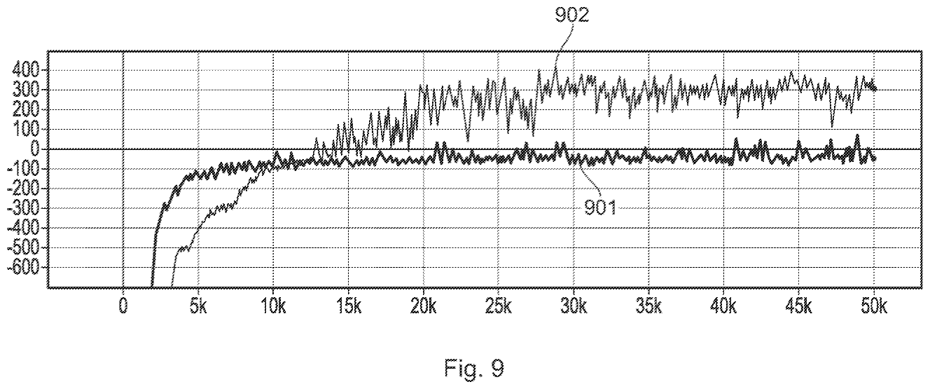

FIG. 9 is a graph illustrating an “observational bottleneck”, where in the case of the fixed non learnable standard deviation (I) 901 (as used in Dreamer), the resulting MBRL model seems to plateau after a few thousand steps, illustrating that the more simplistic world modelling does not continue learning.

On the other hand, by making the observation model also predict the standard deviation, this bottleneck is removed, leading to a more robust latent representation 902. In essence, it is no longer sufficient for an MBRL model to simply be accurate enough to predict the mean, but the whole model must be such that it can also be certain about its predictions. This increased precision yields better performance.

An MBRL model according to embodiments described herein also showcase enhanced distributional flexibility. Depending on the task, one can augment their network, following a similar procedure, in order to learn relevant statistics of any generative distribution.

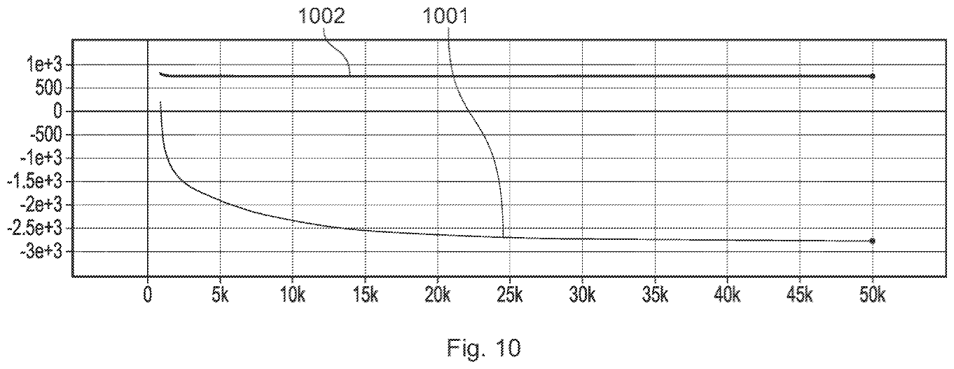

FIG. 10 is a graph illustrating the observation loss 1001 for an MBRL with a learnable standard deviation according to embodiments described herein, and the observation loss 1002 for an MBRL with a fixed standard deviation.

During training the performance of the decoder may be evaluated by computing the likelihood (or probability) of generating the real observation of using the current decoder distribution. Ideally, a high likelihood will be found. This likelihood may be referred to as observation loss. The formula for observation loss may be −log (q(oₜ|sₜ)). Minimizing the observation loss maximizes the likelihood of the decoder generating the real observation oₜ.

As can be seen from FIG. 10, the observation loss 1002 of the MBRL with a fixed standard deviation plateaus early at around 743 loss, which is close to the theoretically optimum loss of approximately 742.5. Whereas, the observation loss 1001 of the MBRL with a learnable standard deviation according to embodiments described herein continues to fall, thereby increasing the likelihood that the decoder will generate the real observation ot.

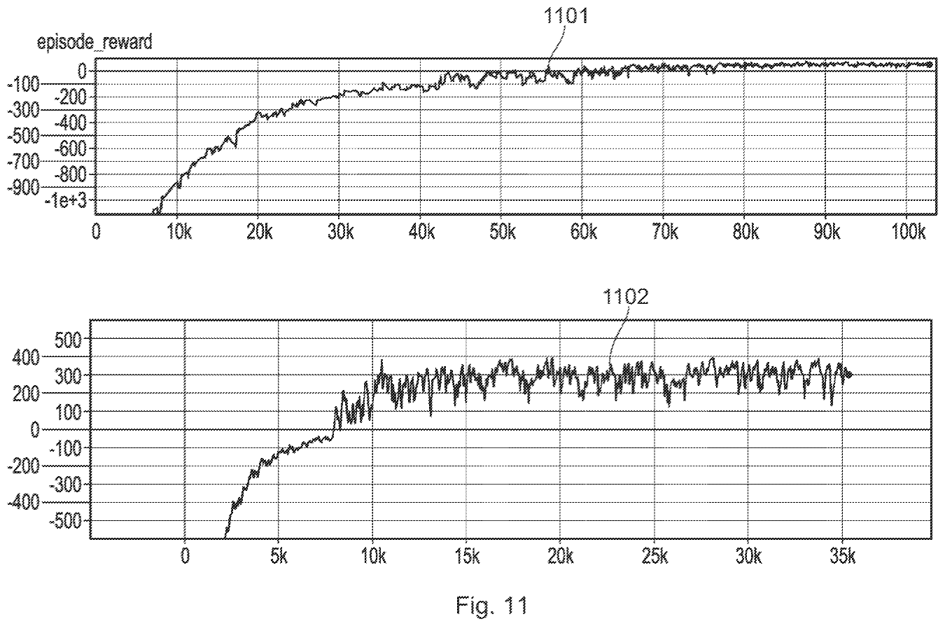

Furthermore, as illustrated in FIG. 11 an MBRL model according to embodiments described herein also manages to exhibit similar performance to a Model Free Soft Actor Critic (SAC) algorithm, while requiring roughly 4 times fewer samples. In particular, FIG. 11 illustrates a comparison between a how quickly a Best Model Free (SAC) agent can tune a cavity filter (illustrated by 1101), and how quickly an MBRL model according to embodiments described herein can tune the cavity filter (illustrated by 1102). The MBRL model according to embodiments described herein (1102) first tunes the filter (with positive reward) at around 8k steps, while the Best Model Free SAC agent (1101) first tunes the filter at around 44k steps. The MBRL model according to embodiments described herein therefore reaches similar performance with around 4 times fewer samples.

| | | | MBRL acc |
|---|---|---|---|
| | | Dreamer | embodiments |
| | SAC | (original) | described herein |
| Accuracy | 99.93% | 69.81% | 98.87%/99.72% |
| Training steps | 100k | 100k | 16k/32k |

As can be seen from table 1, the SAC agent reaches 99.93% after training for 100k steps, whereas the MBRL according to embodiments described herein reaches similar performance at around 16k steps (e.g. close to 99%), while requiring at least 4 times fewer samples. In contrast, the original Dreamer model only reaches 69.81% accuracy with 100k steps.

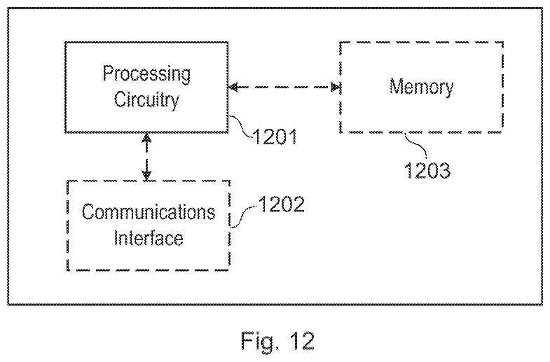

FIG. 12 illustrates an apparatus 1200 comprising processing circuitry (or logic) 1201. The processing circuitry 1201 controls the operation of the apparatus 1200 and can implement the method described herein in relation to an apparatus 1200. The processing circuitry 1201 can comprise one or more processors, processing units, multi-core processors or modules that are configured or programmed to control the apparatus 1200 in the manner described herein. In particular implementations, the processing circuitry 1201 can comprise a plurality of software and/or hardware modules that are each configured to perform, or are for performing, individual or multiple steps of the method described herein in relation to the apparatus 1200.

Briefly, the processing circuitry 1201 of the apparatus 1200 is configured to: obtain a sequence of observations, oₜ, representative of the environment at a time t; estimate latent states sₜ at time t using a representation model, wherein the representation model estimates the latent states sₜ based on the previous latent states sₜ₋₁, previous actions aₜ₋₁ and the observations oₜ; generate modelled observations, o_{m,t}, using an observation model, wherein the observation model generates the modelled observations based on the respective latent states sₜ, wherein the step of generating comprises determining means and standard deviations based on the latent states sₜ; and minimize a first loss function to update network parameters of the representation model and the observation model, wherein the first loss function comprises a component comparing the modelled observations, o_{m,t} to the respective observations oₜ.

In some embodiments, the apparatus 1200 may optionally comprise a communications interface 1202. The communications interface 1202 of the apparatus 1200 can be for use in communicating with other nodes, such as other virtual nodes. For example, the communications interface 1202 of the apparatus 1200 can be configured to transmit to and/or receive from other nodes requests, resources, information, data, signals, or similar. The processing circuitry 1201 of apparatus 1200 may be configured to control the communications interface 1202 of the apparatus 1200 to transmit to and/or receive from other nodes requests, resources, information, data, signals, or similar.

Optionally, the apparatus 1200 may comprise a memory 1203. In some embodiments, the memory 1203 of the apparatus 1200 can be configured to store program code that can be executed by the processing circuitry 1201 of the apparatus 1200 to perform the method described herein in relation to the apparatus 1200. Alternatively or in addition, the memory 1203 of the apparatus 1200, can be configured to store any requests, resources, information, data, signals, or similar that are described herein. The processing circuitry 1201 of the apparatus 1200 may be configured to control the memory 1203 of the apparatus 1200 to store any requests, resources, information, data, signals, or similar that are described herein.

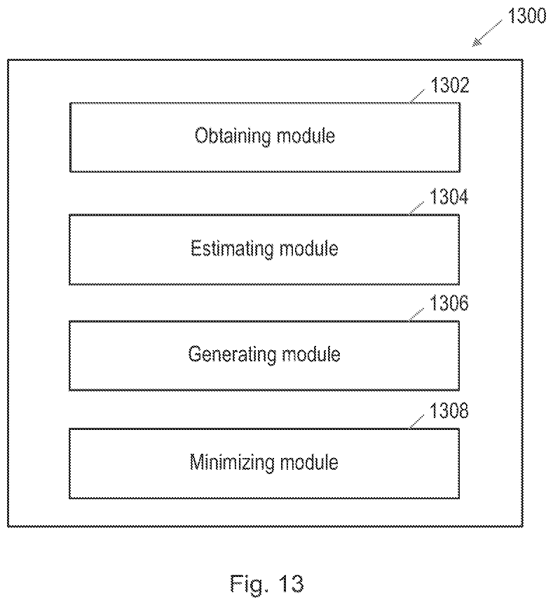

FIG. 13 is a block diagram illustrating an apparatus 1300 in accordance with an embodiment. The apparatus 1300 can train a model based reinforcement learning, MBRL, model for use in an environment. The apparatus 1300 comprises a obtaining module 1302 configured to obtain a sequence of observations, oₜ, representative of the environment at a time t. The apparatus 1300 comprises an estimating module 1304 configured to estimate latent states sₜ at time t using a representation model, wherein the representation model estimates the latent states sₜ based on the previous latent states sₜ₋₁, previous actions aₜ₋₁ and the observations oₜ. The apparatus 1300 comprises a generating module 1306 configured to generate modelled observations, o_{m,t}, using an observation model, wherein the observation model generates the modelled observations based on the respective latent states sₜ, wherein the step of generating comprises determining means and standard deviations based on the latent states sₜ. The apparatus 1300 comprises a minimizing module 1308 configured to minimize a first loss function to update network parameters of the representation model and the observation model, wherein the first loss function comprises a component comparing the modelled observations, o_{m,t} to the respective observations oₜ.

There is also provided a computer program comprising instructions which, when executed by processing circuitry (such as the processing circuitry 1201 of the apparatus 1200 described earlier, cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein therefore provide for improved distribution flexibility. In other words, the proposed embodiments to also model the standard deviation via a separate Neural Network Layer is generalizable to many different distributions, as one can augment their network accordingly to predict relevant distribution statistics. If suited, one can impose certain priors (e.g. positive output) via appropriate activation functions for each statistic.

The embodiments described herein also provide stable training as the MBRL model can steadily learn the standard deviation. As the MBRL model becomes more robust, the MBRL model may gradually decrease the standard deviation of his prediction and become more precise. Unlike maintaining a fixed value for the standard deviation, this change allows for smoother training, characterized by smaller gradient magnitudes.

The embodiments described herein provide Improved Accuracy. Prior to this disclosure the success rate at tuning filters using MBRL peaked at around 70%, however, embodiments described herein are able to reach performance comparable with the previous MFRL agents (e.g. close to 99%). At the same time, the MBRL model according to embodiments described herein is significantly faster, reaching the aforementioned performance with at least 3 to 4 times fewer training samples in comparison to the best MFRL agents.

Since training is faster, one can search the hyperparameter space faster. This may be vital for extending our model to more intricate filter environments. Training is also more stable, which leads to less dependency on certain hyperparameters. This greatly speeds up the process of hyperparameter tuning. Furthermore, convincingly solving a task with a broader range of hyperparameters is a good indicator of its extendibility to more complicated filters.

Therefore, as embodiments described herein effectively train the MBRL model faster, it means that the tuning of cavity filters can be performed much faster. For example, much faster that the current 30 minutes required for a human expert to tune a cavity filter.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for training a model based reinforcement learning, MBRL, model for use in an environment, the method comprising:
obtaining a sequence of observations, oₜ, representative of the environment at a time t;
estimating latent states sₜ at time t using a representation model, wherein the representation model estimates the latent states sₜ based on the previous latent states sₜ₋₁, previous actions aₜ₋₁ and the observations oₜ;
generating modelled observations, o_{m,t}, using an observation model, wherein the observation model generates the modelled observations based on the respective latent states sₜ, wherein the step of generating comprises determining means and standard deviations based on the latent states sₜ; and
minimizing a first loss function to update network parameters of the representation model and the observation model, wherein the first loss function comprises a component comparing the modelled observations, o_{m,t} to the respective observations oₜ.

2. The method as claimed in claim 1 wherein the step of generating further comprises sampling distributions generated from the means and standard deviations to generate respective modelled observations, o_{m,t}.

3. The method as claimed in claim 1 further comprising:
determining a reward rₜ based on a reward model, wherein the reward model determines the reward rₜ based on the latent state sₜ, wherein the step minimizing the first loss function is further used to update network parameters of the reward model, and wherein the first loss function further comprises a component relating to the how well the reward rₜ represents a real reward for the observation oₜ.

4. The method as claimed in claim 1 further comprising:
estimating a transitional latent state s_{trans,t}, using a transition model, wherein the transition model estimates the transitional latent state s_{trans,t} based on the previous transitional latent state s_{trans,t-1} and a previous action aₜ₋₁; wherein the step of minimizing the first loss function is further used to update network parameters of the transition model, and wherein the first loss function further comprises a component relating to how similar the transitional latent state s_{trans,t} is to the latent state sₜ.

5. The method as claimed in claim 3 further comprising:
after minimizing the first loss function, minimizing a second loss function to update network parameters of a critic model and an actor model, wherein the critic model determines state values based on the transitional latent states s_{trans,t} and the actor model determines actions a based on the transitional latent states s_{trans,t}.

6. The method as claimed in claim 5 wherein the second loss function comprises a component relating to ensuring the state values are accurate, and a component relating to ensuring the actor model leads to transitional latent states, s_{trans,t} associated with high state values.

7. The method as claimed in claim 1 wherein the environment comprises a cavity filter being controlled by a control unit.

8. The method as claimed in claim 7 wherein the observations, oₜ, each comprise S-parameters of the cavity filter.

9. The method as claimed in claim 7 wherein the previous actions aₜ₋₁ relate to tuning characteristics of the cavity filter.

10. The method as claimed in claim 1 wherein the environment comprises a wireless device performing transmissions in a cell.

11. The method as claimed in claim 10 wherein the observations, oₜ, each comprise a performance parameter experienced by a wireless device.

12. The method as claimed in claim 11 wherein the performance parameter comprises one or more of: a signal to interference and noise ratio; traffic in the cell and a transmission budget.

13. The method as claimed in claim 10 wherein the previous actions aₜ₋₁ relate to controlling one or more of: a transmission power of the wireless device; a modulation and coding scheme used by the wireless device; and a radio transmission beam pattern.

14. The method as claimed in claim 1 further comprising using the trained model in the environment.

15. The method as claimed in claim 14 wherein the observations, oₜ, each comprise S-parameters of the cavity filter and wherein using the trained model in the environment comprises tuning the characteristics of the cavity filter to produce desired S-parameters.

16. The method as claimed in claim 14 wherein the environment comprises a wireless device performing transmissions in a cell and wherein the using the trained model in the environment comprises adjusting one of: the transmission power of the wireless device; the modulation and coding scheme used by the wireless device; and a radio transmission beam pattern, to obtain a desired value of the performance parameter.

17. An apparatus for training a model based reinforcement learning, MBRL, model for use in an environment, the apparatus comprising processing circuitry configured to cause the apparatus to perform the method as claimed in claim 1.

18. The apparatus of claim 17 wherein the apparatus comprises a control unit for a cavity filter.

19. (canceled)

20. (canceled)
